(19) United States
(12) Patent Application Publication
(10) Pub. No.: US 2024/0158020 A1
(43) Pub. Date: May 16, 2024

(54) FLOOR ASSEMBLY FOR A CARGO VEHICLE

(71) Applicant: Wabash National, L.P., Lafayette, IN (US)

(72) Inventor: Andrzej Wylezinski, Lafayette, IN (US)

(73) Assignee: Wabash National, L.P., Lafayette, IN (US)

(21) Appl. No.: 18/506,333

(22) Filed: Nov. 10, 2023

Related U.S. Application Data
(60) Provisional application No. 63/425,892, filed on Nov. 16, 2022.

(51) Int. Cl. B62D 29/00; B32B 3/28; B32B 5/18; B32B 15/04; B32B 15/095; B62D 27/02; B62D 33/04

(52) U.S. Cl. CPC B62D 29/002; B32B 3/28; B32B 5/18; B32B 15/046; B32B 15/095; B62D 27/02; B62D 33/04; B32B 2605/00

(57) ABSTRACT

A floor assembly for a cargo vehicle is provided. The floor assembly includes a composite decking and a corrugated structure. The composite decking has an upper surface that is configured to support cargo and a lower surface opposite to the upper surface. The lower surface is substantially flat. The corrugated structure is coupled to the lower surface of the composite decking. The corrugated structure includes one or more corrugated sections that each form respective channels.

### CROSS REFERENCE TO RELATED APPLICATIONS

The present application claims the benefit of U.S. Provisional Application No. 63/425,892, entitled “FLOOR ASSEMBLY FOR A CARGO VEHICLE,” filed on Nov. 16, 2022, which is incorporated by reference herein for all purposes in its entirety.

### TECHNICAL FIELD

The present disclosure relates generally to floor assemblies, and more specifically, to floor assemblies of cargo vehicles.

### BACKGROUND

Cargo vehicles, such as cargo vans or semi-trailers, are used in the transportation industry for transporting many different types of cargo. Cargo vehicles include a cargo body, such as a trailer or van body, with a floor assembly. Some floor assemblies include decking on which material handling vehicles (e.g., fork trucks) may drive to access or place cargo inside of the cargo van.

### SUMMARY

Aspects of the present disclosure relate generally to a cargo van that has a floor assembly with a composite decking and corrugated structure that are coupled together.

In some examples, a floor assembly for a cargo vehicle is provided. The floor assembly includes a composite decking and a corrugated structure. The composite decking has an upper surface that is configured to support cargo and a lower surface opposite to the upper surface. The lower surface is substantially flat. The corrugated structure is coupled to the lower surface of the composite decking. The corrugated structure includes one or more corrugated sections that each form respective channels.

In some examples, the composite decking and the corrugated structure are adjoined continuously with respect to each other.

In some examples, the corrugated structure includes at least one of a metal or a composite laminate that includes at least a resin matric and fiber reinforcements.

In some examples, the channels are filled with filler material and the filler material includes one or more of a foam or a low-density polymer.

In some examples, the filler material couples together the corrugated structure and the composite decking.

Some examples further include one or more rails for a slider suspension. The one or more rails are coupled to the corrugated structure.

Some examples further include a plurality of gussets. Each of the one or more rails are coupled to the corrugated structure via the plurality of gussets.

In some examples, the corrugated structure includes one or more nested corrugated sections. Each of the one or more nested corrugated sections includes at least a portion of a first corrugated section and a second corrugated section from the plurality of corrugated sections.

In some examples, the first corrugated section and the second corrugated section are coupled together via one or more of welding, adhesive bonding, or crimping.

In some examples, a floor assembly for a cargo vehicle is provided. The floor assembly includes a composite decking and a corrugated structure. The composite decking has an upper surface that is configured to support cargo and a lower surface that is opposite to the upper surface. The corrugated structure is coupled to the lower surface of the composite decking. The corrugated structure includes a plurality of corrugated sections. The plurality of corrugated sections include a first corrugated section and a second corrugated section. At least a portion of the first corrugated section is nested with at least a portion of the second corrugated section.

In some examples, the one or more corrugated sections each form respective channels. The channels are filled with filler material. The filler material is one or more of a foam or a low-density polymer.

In some examples, the filler material couples the corrugated structure and the composite decking.

In some examples, a method of assembling a floor assembly for a cargo vehicle is provided. The method includes providing a corrugated structure, providing a composite decking having an upper surface that is configured to support cargo and a lower surface that is opposite to the upper surface, and coupling the composite decking to the corrugated structure. The lower surface is substantially flat.

In some examples, the corrugated structure includes a plurality of corrugated sections. Each of the plurality of corrugated sections form respective channels. The method further includes coupling the plurality of corrugated sections together to form one or more nested corrugated sections. The composite decking is coupled to the one or more nested corrugated sections.

Some examples further include pouring a foam material into each of the channels of the plurality of corrugated sections. The coupling the composite decking to the corrugated structure includes coupling the nested corrugated sections to the composite decking via the foam material.

Some examples further include coupling side walls to the corrugated structure.

This summary is provided to introduce a selection of concepts in a simplified form that are further described below in the Detailed Description. This summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTION OF THE DRAWINGS

The foregoing aspects and many of the intended advantages of this invention will become more readily appreciated as the same becomes better understood by reference to the following detailed description when taken in conjunction with the accompanying drawings.

FIG. 1 illustrates a side elevational view of an exemplary cargo body such as a trailer, according to some aspects described herein.

FIG. 2 illustrates a top, front, and right-side view of a portion of a floor assembly for a cargo body, according to some aspects described herein.

FIG. 3 illustrates a top, front, and right-side view of a composite flooring of the portion of the floor assembly of FIG. 2, according to some aspects described herein.

FIG. 4 illustrates a top, rear, and right-side view of a corrugated structure of the portion of the floor assembly of FIG. 2, according to some aspects described herein.

FIG. 5 illustrates a top, rear, and right-side view of the floor assembly of FIG. 2, with the composite flooring removed, according to some aspects described herein.

FIG. 6 illustrates a right-side cross-sectional elevational view of the floor assembly of FIG. 2, according to some aspects described herein.

FIG. 7 illustrates a bottom, front, and right-side view of the floor assembly of FIG. 2, according to some aspects described herein.

FIG. 8 illustrates a gusset, according to some examples provided herein.

FIG. 9 illustrates a partial enlarged view of a portion of the floor assembly of FIG. 2, according to some aspects described herein.

FIG. 10 illustrates an individual corrugated section, according to some aspects described herein.

FIG. 11 illustrates a nested corrugated sheet section, according to some aspects described herein.

FIG. 12 illustrates a method of assembling a floor assembly for a cargo vehicle, according to some aspects described herein.

FIG. 13 illustrates a method of manufacturing a composite floor assembly, according to some aspects described herein.

FIG. 14 illustrates a top perspective view of a portion of a floor assembly for a cargo body, according to some aspects described herein.

FIG. 15 illustrates the floor assembly of FIG. 14, with a portion of a decking of the floor assembly hidden to show latching blocks, according to some aspects described herein.

FIG. 16 illustrates a top perspective view of a corrugated structure of the portion of the floor assembly of FIG. 14, according to some aspects described herein.

FIG. 17 illustrates an enlarged cross-sectional view of the portion of the floor assembly of FIG. 14, according to some aspects described herein.

FIG. 18 illustrates the latching blocks of FIG. 15 according to some aspects described herein.

Corresponding reference characters indicate corresponding parts throughout the several views. Although the drawings represent embodiments of various features and components according to the present disclosure, the drawings are not necessarily to scale and certain features may be exaggerated in order to better illustrate and explain the present disclosure. The exemplification set out herein illustrates an embodiment of the invention, and such an exemplification is not to be construed as limiting the scope of the invention in any manner.

### DETAILED DESCRIPTION OF THE DRAWINGS

It is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

While the structures and components disclosed herein may be embodied in many different forms, several specific embodiments are discussed herein with the understanding that the embodiments described in the present disclosure are to be considered only exemplifications of the principles described herein, and the disclosure is not intended to be limited to the embodiments illustrated. Further, throughout the disclosure, the terms “about”, “substantially”, and “approximately” mean plus or minus 5% of the number or geometric constraint that each term precedes. For example, about 100 may mean 100+/−5. Additionally, or alternatively, substantially and/or generally orthogonal may mean that any 90-degree angle related to the described orthogonality may be between 85.5 degrees and 94.5 degrees (inclusive).

As mentioned above, cargo vehicles are used in the transportation industry for transporting many different types of cargo. Cargo vehicles include a cargo body, such as a trailer or van body, with a floor assembly. Some floor assemblies include decking on which fork trucks, or other material handling vehicles, may drive to place or access cargo inside of the cargo body.

Conventional floor assemblies of cargo vehicles may include laminated hardwood (e.g., white or red oak hardwood). For example, wood boards may be attached to steel cross members via mechanical couplings (e.g., screws, bolts, rivets, etc.). However, the wood boards may be heavy which undesirably adds weight to the cargo vehicle. Further, failure of the conventional floor assemblies may be commonly due to the mechanical couplings breaking, such as from the stress of a material handling vehicles driving on the composite decking. For example, a forklift driving on the floor assembly of a cargo vehicle may weigh about 17,000 lbs, which may apply significant stress to mechanical couplings.

Still further, manufacturing floor assemblies with hardwood may be relatively inefficient (e.g., requiring a relatively large amount of time and/or money), such as because wood is becoming increasingly scarce and is heavy to transport. Therefore, there exists a need for a lightweight and relatively low cost floor assembly that is strong enough to support material handling vehicles that may be placing cargo inside of the cargo vehicle.

It is with respect to these and other general considerations that embodiments have been described herein. Also, although relatively specific problems have been discussed, it should be understood that the embodiments should not be limited to solving the specific problems identified herein. Aspects of the present disclosure can be advantageous to address the above problems, as well as additional problems that may be recognized by those of ordinary skill in the art. Generally, as explained herein, the present disclosure provides a floor assembly for cargo vehicles. The floor assembly includes a composite decking and a corrugated structure that is adjoined to the composite decking. In some examples, the corrugated structure is adjoined to the composite decking in a continuous manner. The composite decking creates a surface for a material handling vehicle (e.g., a fork truck) to drive on, while placing cargo inside of the cargo vehicle.

In the floor assembly provided herein, wood from conventional assemblies may be eliminated and, instead, replaced with a composite material, such as a composite panel. The composite panel may be manufactured in a continuous fashion, for high production rates and relatively lower costs of production. In some examples, unlike wood, the composite material provided herein will not absorb water, split, rot, etc. Also, unlike wood, use of the composite material may eliminate a need for mechanical coupling to steel cross members therebelow, thereby eliminating failure of the floor assemblies, due to a breakage of the mechanical couplings.

The corrugated structure that is adjoined to the composite decking may be advantageous over existing floor constructions for significantly reducing weight and increasing stiffness of the floor assembly. In some examples, the corrugated structure can be fabricated from a light weight metal, such as a light gauge steel sheet. The corrugated structure may further be galvanized or otherwise protected from corrosion. Additionally, or alternatively, the corrugated structure can be made, at least in part, of a composite laminate of different resin matrices and various fiber reinforcement.

In some examples, the corrugated structure may have thin walls that are supported by filling channels or cavities formed in the corrugated structure with light-weight filler material. The filler material may be made of foam and/or a low-density polymer. The filler materials are selected based on their compression and shear properties in order to provide support to any channels or cavities of the corrugated structure. Additionally, in some examples, the filler material may serve as a binder to couple the composite decking of the flooring assembly to the corrugated structure beneath the composite decking. In some examples, an adhesive may be used to couple the flooring to the corrugated structure therebeneath. In some examples, the flooring can be coupled to the corrugated structure via an interference fit, or a push-to-lock feature, or a snappable attachment. Additional and/or alternative attachment mechanisms that do not require mechanical fasteners may be recognized by those of ordinary skill in the art.

In some examples, standard body rails (e.g., for a slider suspension) may be attached to a bottom side of the corrugated structure. Gussets, according to aspects described herein, may be used to increase a strength of the connections between the corrugated structure and the body rails. In some examples, the corrugated structure may include a plurality of corrugated sections that are adjoined together to form a corrugated structure that spans the length of the floor. The sections can be joined by spot welding, bonding, crimping seams, or using other methods. In certain locations of the corrugated structure, the corrugated structure can have a double thickness, such as from overlapping corrugated sections and nesting them together.

The floor assembly provided herein can allow for the elimination (e.g., fully or partially) of wood flooring, mechanical couplings for attachments, metallic I-beam crossmembers, etc. In some examples, the floor assembly provided herein will use composite panel decking with a corrugated structure beneath to provide strength and stiffness. The decking and the corrugated structure can be continuously coupled to work in unison to provide resistance to forces and bending moments exerted onto the cargo vehicle. The floor assembly provided herein can increase cost savings in materials, such as by replacing wood, which is becoming scarce and expensive, with man-made or composite materials. Further, the floor assembly provided herein can reduce a cost of manufacturing and increase a rate of production due to an ease of manufacturing composite materials with continuous manufacturing and/or assembly processes. Additional and/or alternative advantages of aspects described herein will be recognized by those of ordinary skill in the art, at least in light of the teachings described herein.

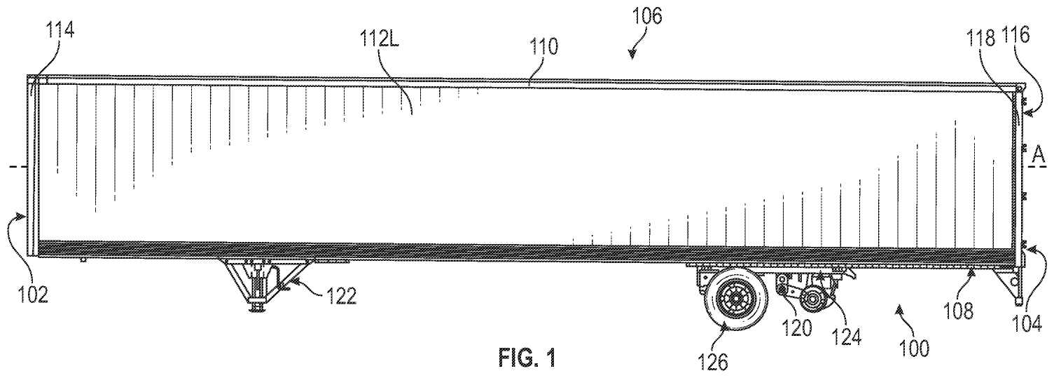

FIG. 1 illustrates a side elevational view of an exemplary cargo body or trailer 100, according to some aspects of a cargo vehicle described herein. The illustrative trailer 100 extends along a longitudinal axis A from a front end 102 to a rear end 104. The illustrative trailer 100 includes a cargo body 106. The cargo body 106 includes a floor assembly 108, a roof 110, one or more trailer sidewalls or walls 112 (e.g., a first or right trailer sidewall (not shown) and a second or left trailer sidewall 112L), a front wall or nose 114, and a rear door assembly 116 having a rear frame 118 and a door (not shown) to access the cargo body 106. The trailer 100 may be used for supporting and/or transporting cargo. The floor assembly 108 may be stiffer than a conventional trailer floor, at least in part, due to a composite decking 128 and/or corrugated structure 130, as will be discussed further herein.

Moving from the front end 102 to the rear end 104, in addition to the cargo body 106, the trailer 100 also includes a coupler assembly (not shown), a suspension assembly 120 (FIG. 1), a landing gear assembly 122, a fuel tank assembly (not shown), and a slide rail assembly 124. The coupler assembly is configured to couple the cargo body 106 to a motorized tractor, chassis, or another vehicle (not shown). The landing gear assembly 122 is configured to support the cargo body 106 on the ground. The slide rail assembly 124 is configured to couple the cargo body 106 to a rear wheel assembly 126. The front end 102 of the cargo body 106 may be supported atop the tractor (not shown) of the cargo vehicle via the coupler assembly (not shown) in a transport condition and further supported atop the landing gear assembly 122 in a stationary condition, and the rear end 104 of the cargo body 106 may be supported atop the rear wheel assembly 126 in either the transport or the stationary condition.

In the illustrated example of FIG. 1, cargo body 106 of trailer 100 is an enclosed body. The cargo body 106 may be refrigerated and/or insulated to transport temperature-sensitive cargo. While the concepts of this disclosure may be described generally in relation to a trailer 100, it will be understood that they are equally applicable to other vehicles generally, and more specifically to dry freight trailers, refrigerated trailers, flatbed trailers, small personal trailers and/or box or van trucks or truck bodies, and the like. Accordingly, those skilled in the art will appreciate that the present invention may be implemented in a number of different applications and examples and is not specifically limited in its application to the particular examples depicted herein.

The cargo body 106 of trailer 100 may be constructed, at least in part, of composite materials. For example, the floor assembly 108, roof 110, right sidewall (not shown), left sidewall 112L, and/or nose 114 of cargo body 106 may be constructed of composite materials. As such, the floor assembly 108, roof 110, right sidewall (not shown), left sidewall 112L, and/or nose 114 of cargo body 106 may be referred to herein as composite structures. It should be recognized that advantageous material properties of composite materials, such as strengthening properties, stiffness, reduced weight, etc., translate to the composite structure formed of the composite materials described herein.

Composite materials are generally formed by combining two or more different constituents that remain separate and distinct in the final composite material. Exemplary composite materials for use in the composite cargo body 106 include fiber-reinforced plastics (FRP), for example carbon-fiber-reinforced plastics (CRP). Each composite structure may be a single, unitary component, which may be formed from a plurality of constituents or layers permanently coupled together. Other elements of the cargo body 106 may be constructed of non-composite (e.g., metallic) materials. For example, the rear door assembly 116 of the cargo body 106 may be constructed of metallic materials.

The composite construction of the cargo body 106 may present certain advantages. First, because the composite structures may lack structural metallic components, the composite cargo body 106 may have a reduced heat loss coefficient (Ua) and improved thermal efficiency. Also, the composite cargo body 106 may be configured in a manner which minimizes outgassing of blowing agents, air loss, and water intrusion. Additionally, the composite cargo body 106 may be lighter in weight than a typical metallic and/or wood cargo body, which may improve fuel efficiency. Further, the composite cargo body 106 may have fewer metallic structures than a typical cargo body, which may make the cargo body 106 less susceptible to corrosion. Also, the composite cargo body 106 may include fewer parts than a typical metallic cargo body, which may simplify construction, reduce inventory, and reduce variation in manufacturing. Further, the composite cargo body 106 may be suitable for use with sensitive cargo, including foodstuffs, because the composite materials may be inert to avoid reacting with the cargo and other materials and because the composite materials may be easy to clean and maintain to ensure proper hygiene. As a result, the composite cargo body 106 may qualify as “food grade” equipment.

The composite structures of the present disclosure may contain one or more structural supports or preforms. The preform may have a structural core that has been covered with an outer fabric layer or skin. The outer skin may be stitched or otherwise coupled to the underlying core and/or any surrounding layers. The core may be extruded, pultruded, or otherwise formed into a desired shape and cut to a desired length. In some examples, the core is a polyurethane foam material or another foam material, and the outer skin is a non-woven spun bond polyester material, a fiberglass fabric, or another suitable material. Advantageously, in addition to its structural effect, the foam core may have an insulating effect in certain applications, including refrigerated trucking applications. Exemplary preforms include PRISMA® preforms provided by Compsys, Inc. of Melbourne, Florida. Additional details of the preforms are disclosed in U.S. patent application Ser. No. 15/439,789, filed Feb. 22, 2017, and entitled “COMPOSITES FORMED FROM CO-CURE ADHESIVE”, the complete disclosure of which is expressly incorporated by reference herein.

Both the core and the outer skin of the preform may be selected to accommodate the needs of the particular application. For example, in areas of the final structure requiring more strength and/or insulation, a low-density foam may be replaced with a high-density foam or a hard plastic block. The individual preforms may also be sized, shaped, and arranged in a manner that accommodates the needs of the particular application. For example, in areas of the final structure requiring less strength, the preforms may be relatively large in size, with the foam cores spanning relatively large distances before reaching the surrounding outer skins. By contrast, in areas of the final structure requiring more strength, the preforms may be relatively small in size, with the foam cores spanning relatively small distances before reaching the surrounding outer skins. Stated differently, the preforms may be shaped as relatively wide panels in areas of the final structure requiring less strength and as relatively narrow support beams in areas of the final structure requiring more strength.

The composite structures of the present disclosure may also contain one or more reinforcing materials or layers around the preforms. Each reinforcing layer may contain reinforcing fibers and may be capable of being impregnated and/or coated with a resin. Suitable fibers include carbon fibers, glass fibers, cellulose, or polymers, for example. The fibers may be present in fabric form, which may be mat, woven, non-woven, or chopped, for example. Exemplary reinforcing layers include chopped fiber fabrics, such as chopped strand mats (CSM), and continuous fiber fabrics, such as 0°/90° fiberglass fabrics, +45°/−45° fiberglass fabrics, +60°/−60° fiberglass fabrics, 0° warp unidirectional fiberglass fabrics, and other stitched fiber fabrics, for example. Such fabrics are commercially available from Vectorply Corporation of Phenix City, Alabama. Exemplary fabrics include the E-LM 1810 fiberglass fabric with 0° unidirectional fibers, the E-LTM 3610 fiberglass fabric with 0°/90° fibers, and the E-LTM 2408 fiberglass fabric with 0°/90° fibers, for example.

According to some examples of the present disclosure, a plurality of different reinforcing layers may be stacked together and used in combination. For example, a chopped fiber fabric (e.g., CSM) may be positioned adjacent to a continuous fiber fabric. In this stacked arrangement, the chopped fibers may help support and maintain the adjacent continuous fibers in place, especially around corners or other transitions. Also, the chopped fibers may serve as a web to resist column-type loads in compression, while the adjacent continuous fibers may resist flange-type loads in compression. Adjacent reinforcing layers may be stitched or otherwise coupled together to simplify manufacturing, to ensure proper placement, and to prevent shifting and/or bunching.

In some examples, the composite structures may be made of thermoplastics. The thermoplastics may be easily recyclable. Accordingly, some composite structures according to the present disclosure may be formed from thermoplastics that are recycled from one or more other composite structures, using recycling methods that may be recognized by those of ordinary skill in the art.

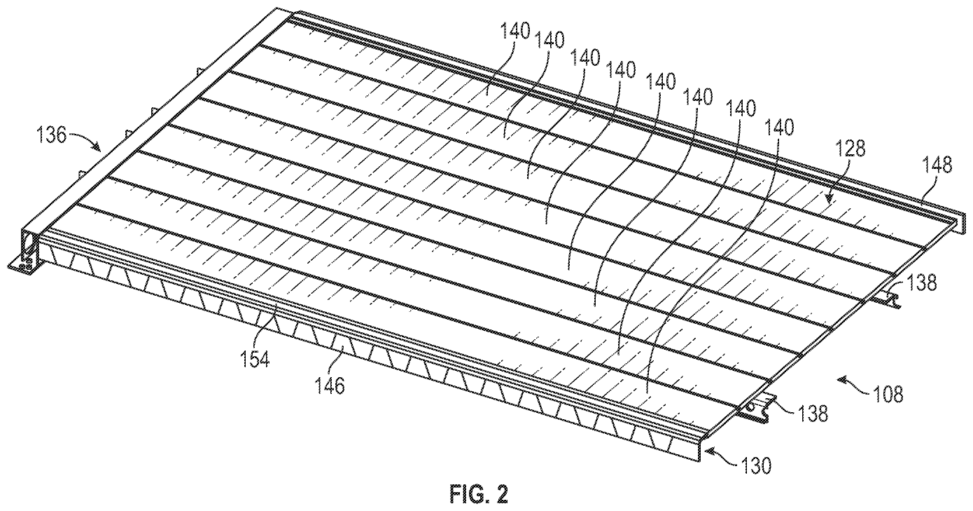

FIG. 2 illustrates a top, front, and right-side view of a portion of the floor assembly 108 for a cargo vehicle, according to some aspects described herein. At least a portion of the floor assembly 108 from FIG. 1 is shown in FIGS. 2-10. The floor assembly 108, in its entirety, may extend, up to, the longitudinal length of the trailer 100, as measured with respect to the longitudinal axis A (see FIG. 1). Additionally, or alternatively, the floor assembly 108 may extend up to a portion of the longitudinal length of the trailer 100, as measured with respect to the longitudinal axis A.

The floor assembly 108 includes the composite decking 128. The composite decking 128 has an upper surface 132 and a lower surface 134 that is opposite to the upper surface 132. The upper surface 132 is configured to support cargo and/or a material handling vehicle that disposes cargo onto the upper surface 132. The floor assembly 108 further includes the corrugated structure 130. The corrugated structure 130 is coupled to the lower surface 134 of the composite decking 128. The corrugated structure 130 is described in further detail later herein. The composite decking 128 and the corrugated structure 130 may be adjoined continuously with respect to each other, such that, for example, at every location along a length and/or width of the composite decking 128, the corrugated structure 130 directly or indirectly (e.g., via filler material) contacts the composite decking 128.

The composite decking 128 is substantially flat. For example, the upper surface 132 and/or the lower surface 134 may be substantially flat. Specifically, in some examples, the upper surface 132 and the lower surface 134 may each define planar surfaces that are parallel with respect to each other. In some examples, the composite decking 128 may be substantially solid between the upper surface 132 and the lower surface 134 (e.g., void of cutouts, cavities, channels, or other substantial negative space). Further, the upper surface 132 and the lower surface 134 may be substantially smooth. Additionally, or alternatively, the composite decking 128 (e.g., the upper surface 132 and/or the lower surface 134) may be void of lumps, ribs, corrugations, or other structures that those of ordinary skill in the art may associate with uneven surfaces.

In some examples, the floor assembly 108 includes a rear frame sill or rear sill 135. A rear bumper 136 (see FIG. 1) may be coupled to the rear sill 135 to help to dissipate forces from impact of a rear end crash to the trailer 100. Further, in some examples, the floor assembly 108 includes one or more rails 138 that form at least part of the slide rail assembly 124 (e.g., for a slider suspension). The one or more rails 138 may be coupled to the corrugated structure 130. The coupling of the slide rail assembly 124 to the corrugated structure 130 is described in further detail later herein.

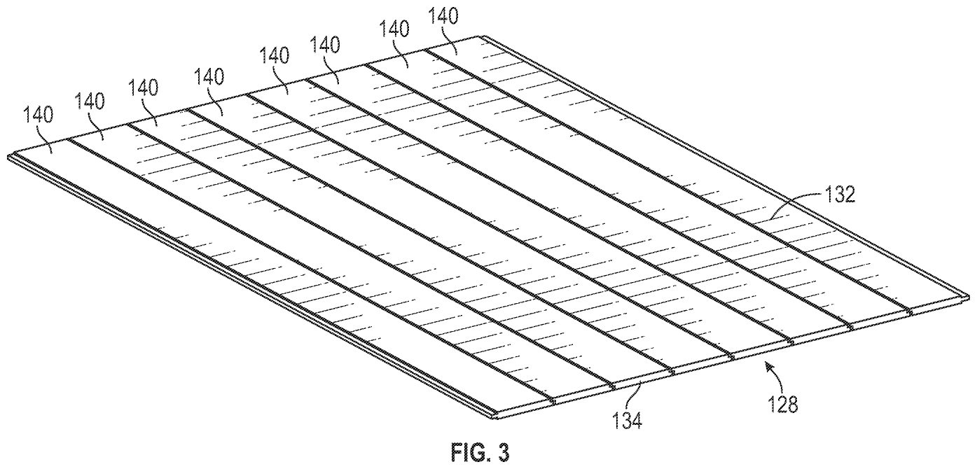

FIG. 3 illustrates a top, front, and right-side view of the composite decking 128 of the portion of the floor assembly 108, according to some aspects described herein. The composite decking 128 may be formed of one or more panels 140. In some examples, the composite decking 128 may be formed of a plurality of panels 140 that are coupled together adjacent to each other. Additionally or alternatively, the composite decking 128 may be a single panel that extends the full width of the trailer 100.

The composite decking 128 may increase a stiffness of the floor assembly 108 because the panels 140 can be immediately adjacent to each other and continuously supported by the corrugated structure 130 therebelow. Comparatively, steel I-beam crossmembers in a conventional floor assembly may be spaced apart at a distance of between 10″-12″. Since the individual I-beams are not directly connected to each other, there may be relatively low longitudinal stiffness for conventional floors of trailers.

In some examples, the one or more panels 140 may have a width of about a half-foot, or about one foot, or about two feet. In some examples, the one or more panels 140 may be generally rectangular, such as to improve efficiency of continuously manufacturing the one or more panels 140. However, it should be recognized by those of ordinary skill in the art that the one or more panels 140 may be manufactured into any shape and/or size.

In some examples, the composite decking 128 may be thinner than conventional decking. For example, the composite decking 128 may be less than one inch in thickness, or about 0.75 inches thick, or about 0.5 inches thick. Comparatively, conventional decking may be greater than one inch in thickness due to limitations in how thin wooden boards are able to be manufactured. However, composite materials, of which the panels 140 are made, allow for greater flexibility in manufacturing than conventional wooden boards. In some examples, the panels 140 may be foamed polymer. In some examples, the panels 140 may be foam polymer reinforced with fibers. In some examples, the panels 140 may be urethane with glass fibers. In some examples, the glass fibers are randomly oriented short glass fibers throughout at least a portion of a thickness of the panels 140 and continuous fibers adjacent the upper surface 132 and/or the lower surface 134.

The panels 140 may be coupled together, for example, via adhesives, chemical bonding, snappable attachment, etc. In some examples, two adjacent panels 140 may be coupled together by a portion of a first panel of the panels 140 overlaying (e.g., resting upon) a portion of a second panel of the panels 140. Therefore, the panels 140 may be sized and shaped to support each other along a width of the corrugated structure 130.

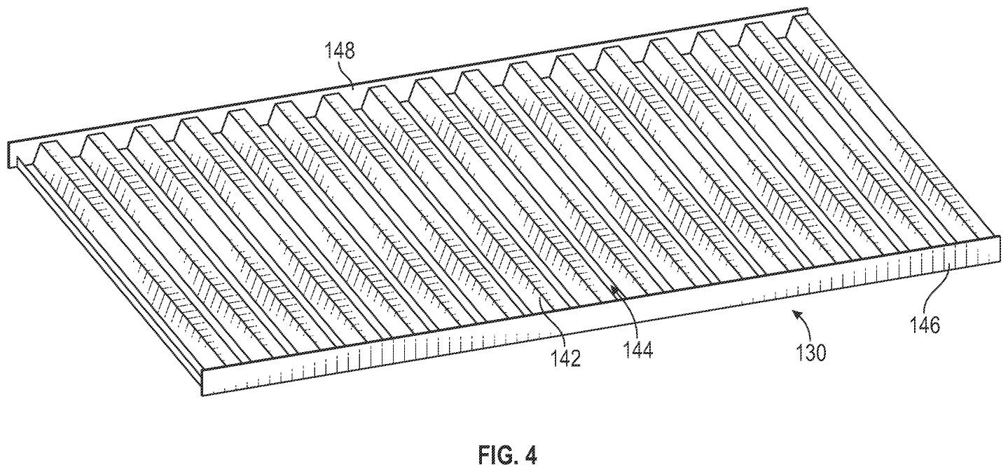

FIG. 4 illustrates a top, rear, and right-side view of the corrugated structure 130 of the portion of the floor assembly 108, according to some aspects described herein. The corrugated structure 130 includes one or more corrugated sections 142 that each include or form respective channels 144. In some examples, the corrugated structure 130 includes (e.g., is formed of) a metal, such as, a steel (e.g., high strength steel, an alloy containing steel and copper, such as weathering steel, etc.), an aluminum, etc. In some examples, the metal may be galvanized or otherwise protected from corrosion. Additionally, or alternatively, in some examples the corrugated structure 130 includes (e.g., is formed of) a composite laminate. The composite laminate may include at least a resin matrix and fiber reinforcements. In some examples, the corrugated structure 130 includes at least one of the steel or the composite laminate.

Generally, the corrugated structure 130 helps to increase the carrying load of the composite decking 128, such as for a material handling vehicle to drive thereon. The corrugated structure 130 may be roll formed, pressed, stamped, or otherwise manufactured using methods recognized by those of ordinary skill in the art. The corrugated structure 130 may have a width of about 22.5 inches and/or a height of about 4 inches. However, in some examples, the corrugated structure may be manufactured with any width or height desired by a manufacturer.

In some examples, the one or more corrugated sections 142 is a plurality of corrugated sections 142. The plurality of corrugated sections 142 may be coupled together, such as, for example, via one or more of welding, adhesive bonding, chemical bonding, or crimping. Additional and/or alternative mechanisms for coupling together the plurality of corrugated sections 142 may be recognized by those of ordinary skill in the art.

Still referring to FIG. 4, a first side wall 146 and a second side wall 148 may be part of or coupled to the corrugated structure 130. The first side wall 146 and the second side wall 148 may be comprised of high strength steel so as to have strength or other properties for increasing a stiffness of and/or to reinforce the corrugated structure. Further, the first side wall 146 and the second side wall 148 may be relatively thin (e.g., 72 thousandths of an inch) such that they occupy relatively little space. The first side wall 146 and the second side wall 148 may be removably coupled to the corrugated structure 130 via mechanical fasters, such as bolts. The bolts may be easy to replace compared to some examples where the first side wall 146 and the second side wall 148 may be coupled to the corrugated structure 130 via rivets. In some examples, the first side wall 146 and the second side wall 148 may be otherwise integrally formed with or permanently coupled to the corrugated structure 130, such as via adhesive, welding, ties, through a forming process, etc.

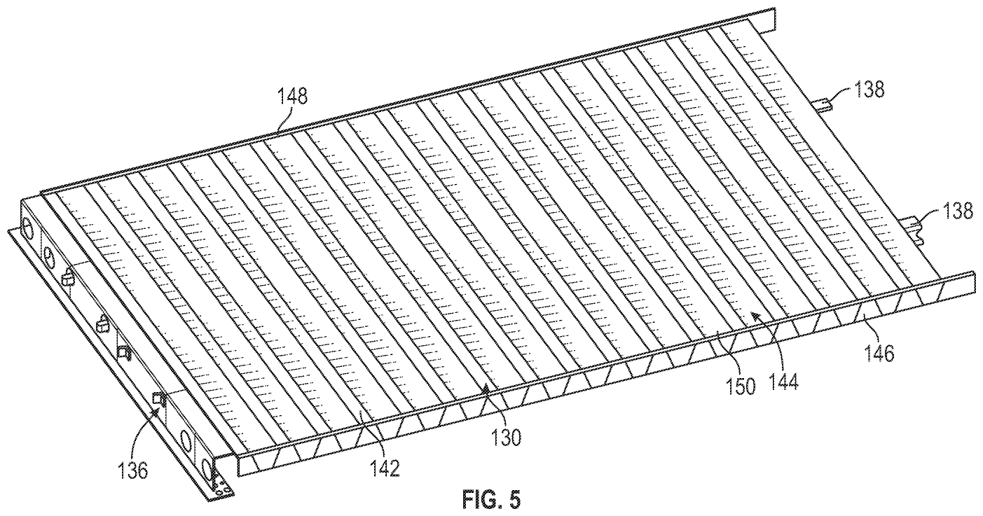

FIG. 5 illustrates a top, rear, and right-side view of the floor assembly 108 with the composite decking 128 removed. As shown in FIG. 5, the channels 144 may be filled with filler material 150. The filler material 150 may include one or more of a foam or a polymer, such as a low-density polymer. For example, a polyurethane resin may be mixed with a foaming agent to create the filler material 150. In some examples, the filler material 150 includes a liquid, a semi-solid, and/or a solid material that then expands within the channels 144. Additionally, or alternatively a foam recognized by those of ordinary skill in the art may be provided with a polymer resin and a foaming agent to create the filler material 150.

In some examples, each and every one of the channels 144 may be filled with filler material 150. Alternatively, in some examples, one or more of the channels 144 may be filled with filler material 150, while one or more of the channels 144 may not be filled with filler material 150. Further, in some examples, each of the channels 144 that contain filler material 150 may contain the same filler material 150. Alternatively, in some examples, one or more of the channels 144 may contain a first type of the filler material 150 and one or more of the channels may contain a second type of the filler material 150. In some examples, the filler material 150 is applied during and/or after a manufacture of the corrugated structure 130. In some examples, the filler material 150 includes a pre-made foam core, such as the PRISMA® preform discussed earlier herein, which may be shaped to fit within the channels 144. In some examples, the pre-made foam cores may be applied and/or positioned within the channels 144 during and/or after a manufacture of the corrugated structure 130.

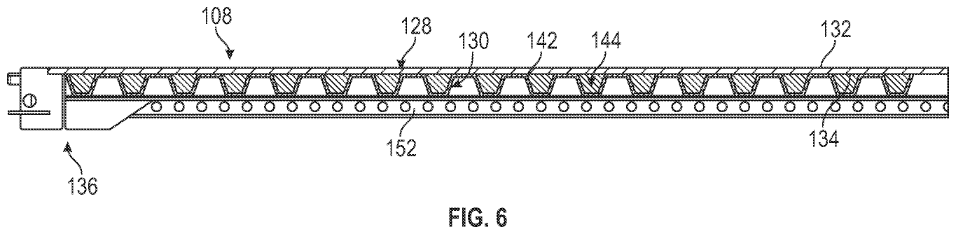

FIG. 6 illustrates a right-side cross-sectional elevational view of the floor assembly 108, according to some aspects described herein. As shown in FIG. 6, the composite decking 128 may be continuously adjoined to the corrugated structure 130. In some examples, the filler material 150 couples together the corrugated structure 130 and the composite decking 128. For example, the composite decking 128 may contact both the corrugated structure 130 and the filler material 150, disposed within the channels 144 of the corrugated structure 130, to be adjoined to the corrugated structure 130 such that the filler material 150 bonds or adheres the corrugated structure 130 to the composite decking 128. Alternatively, in some examples, the composite decking 128 may be otherwise coupled to the corrugated structure 130, such as via adhesives, chemical bonding, fasteners, snappable attachment, etc.

The composite decking 128 may be reinforced and/or stiffened by one or more of the corrugated structure 130, the rear bumper 136, and/or the rails 138. For example, each of the corrugated structure 130, the rear bumper 136, and/or the rails 138 may dissipate forces that are applied to the trailer 100 when in use. The composite decking 128 may be flush mounted or coupled to the corrugated structure 130. The rails 138 may be coupled flush to the corrugated structure 130. Further, the composite decking 128 may be in contact with the rear sill 135.

Generally, the floor assembly 108 described herein provides a strong, compact structure to support loads disposed thereon (e.g., cargo, material handling vehicles, etc.), while also being able to dissipate forces from rear or tangential loads that may be incurred during operations of the trailer 100.

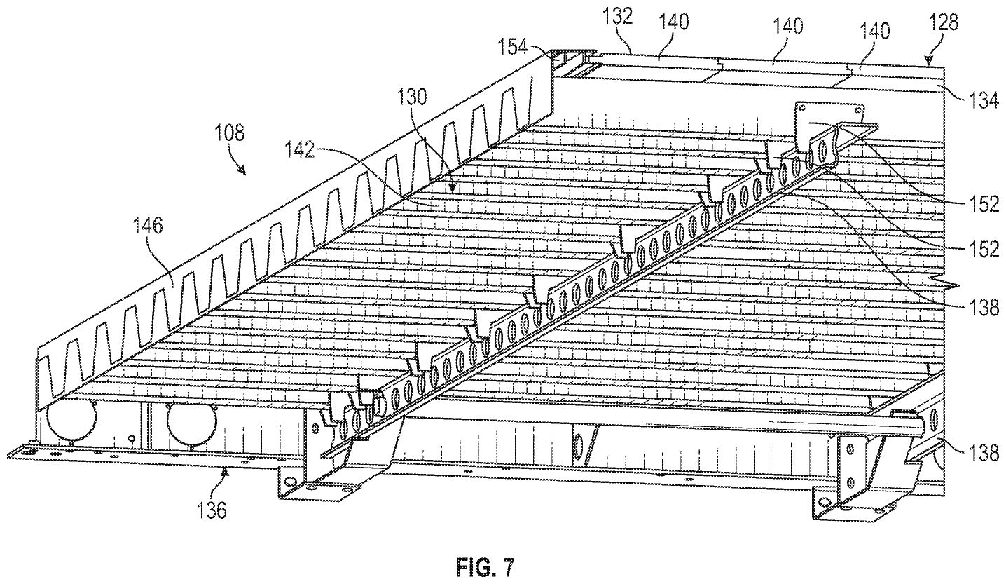

FIG. 7 illustrates a bottom, front, and right-side view of the floor assembly 108, according to some aspects described herein. In some examples, the floor assembly 108 includes a plurality of gussets 152. The rails 138 may be coupled to the corrugated structure 130 via the plurality of gussets 152. For example, the gussets 152 may extend between sidewalls of the channels 144 of the corrugated structure 130 to one or more of the rails 138.

In some examples, the gussets 152 are welded to the corrugated structure 130 to reduce a need for holes and screws in the floor assembly 108. Additionally, or alternatively, in some examples, the gussets 152 are coupled to the corrugated structure 130 via one or more of fasteners, adhesive, chemical bonding, ties, or any other coupling that may be recognized by those of ordinary skill in the art. Similarly, the gussets 152 may be welded to the rails 138. Additionally, or alternative, the gussets 152 may be coupled to the rails 138 via one or more fasteners, adhesive, chemical bonding, ties, or any other coupling that may be recognized by those of ordinary skill in the art. In some examples, the gussets 152 extend from the corrugated structure 130 at an angle with respect to the composite decking 128, such as due to an angle at which the channels 144 of the corrugated structure 130 are formed.

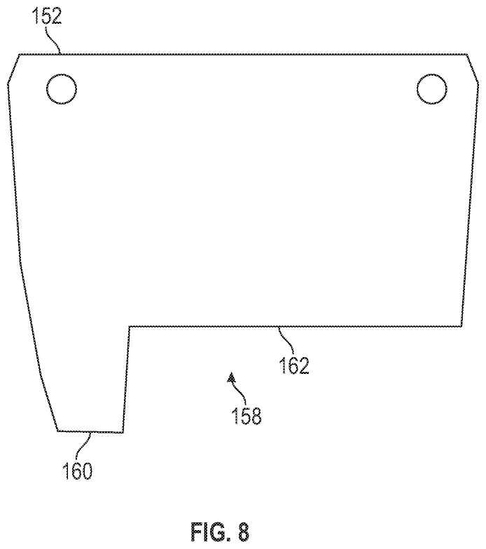

FIG. 8 illustrates the gusset 152 according to some examples provided herein. In some examples, the gussets 152 may include a cutout 158 that is sized and shaped to receive at least a portion of the rails 138. For example, the gussets 152 may L-shaped, wherein a lateral tab 160 of the gusset 152 extends beyond (e.g., downwardly past) a lower edge 162 of the gussets 152 at which the rails 138 are received. The lower edge 162 may extend continuously from the tab 160 for the remaining width of the gusset 152, such that the gusset 152 does not interfere with a component sliding along the rails 138, which are received at the cutout 158.

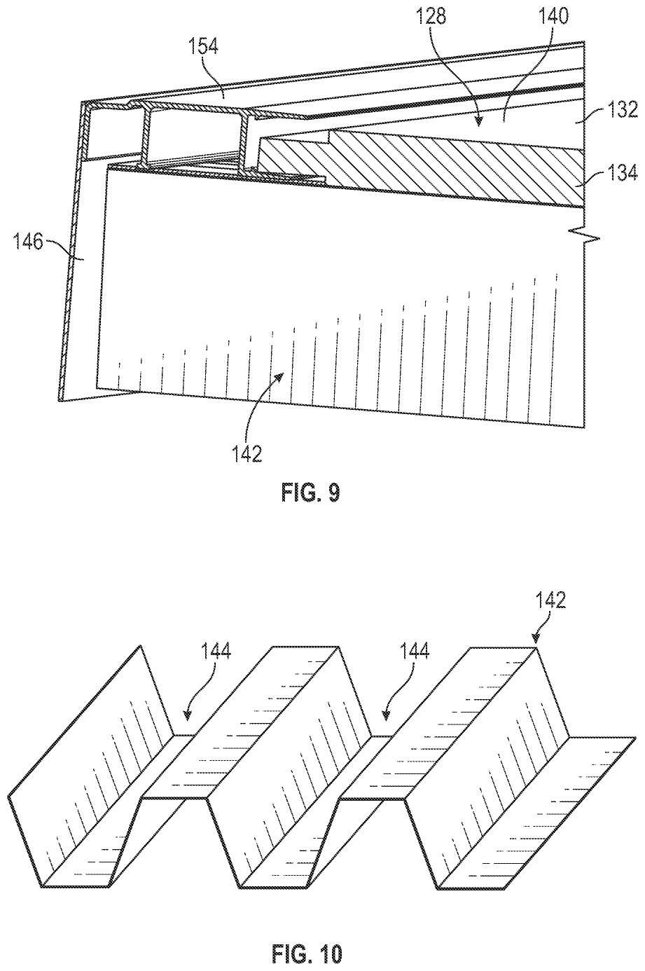

FIG. 9 illustrates a partial, enlarged view of a portion of the floor assembly 108, according to some aspects described herein. In some examples, the floor assembly 108 includes a hollow extrusion 154 disposed between the composite decking 128 and at least one of the first side wall and second side wall 148. The hollow extrusion 154 may be coupled to at least one of the first side wall and second side wall 148. Further, at least a portion of the composite decking 128 may be received within at least a portion of the hollow extrusion 154.

Electrical wires, cables, pneumatic lines, and/or hydraulic lines may be fed through the hollow extrusion 154 for use with various components such as suspensions, brakes, air horns, etc. The hollow extrusion 154 may be made of a lightweight metal, such as aluminum. Alternatively, the hollow extrusion 154 may be made of any other material that is recognized by those of ordinary skill in the art for manufacturing hollow extrusions.

FIG. 10 illustrates an individual corrugated section of the plurality of corrugated sections 142, according to some aspects described herein. The corrugated section 142 may form at least a portion of the corrugated structure 130. The corrugated section 142 may be roll formed, pressed, stamped, or otherwise manufactured using methods recognized by those of ordinary skill in the art. The corrugated section 142 may have a width of about 22.5 inches and/or a height of about 4 inches. However, in some examples, the corrugated section may be manufactured with any width or height desired by a manufacturer.

In some examples, the channels 144 formed by the corrugated section 142 may be generally trapezoidal (e.g., two laterally opposed walls 164a, 164b extending outwardly from a center wall 166 at obtuse angles with respect to the center wall 166). Additionally, or alternatively, in some examples, the channels 144 formed by the corrugated section 142 may be generally rectangular (e.g., where the two laterally opposed walls 164a, 164b extend orthogonal from the center wall 166), or generally curved (e.g., the two lateral opposed walls 164a, 164b extending curvedly from the center wall 166), etc.

In some examples, each of the channels 144 formed by the corrugated section 142 may be the same size and/or shape. Alternatively, one or more of the channels 144 formed by the corrugated section 142 may be different sizes and/or shapes. Further, in some examples, the corrugated section 142 may define a single channel. Alternatively, in some examples, the corrugated section 142 define two, or three, or any number of channels.

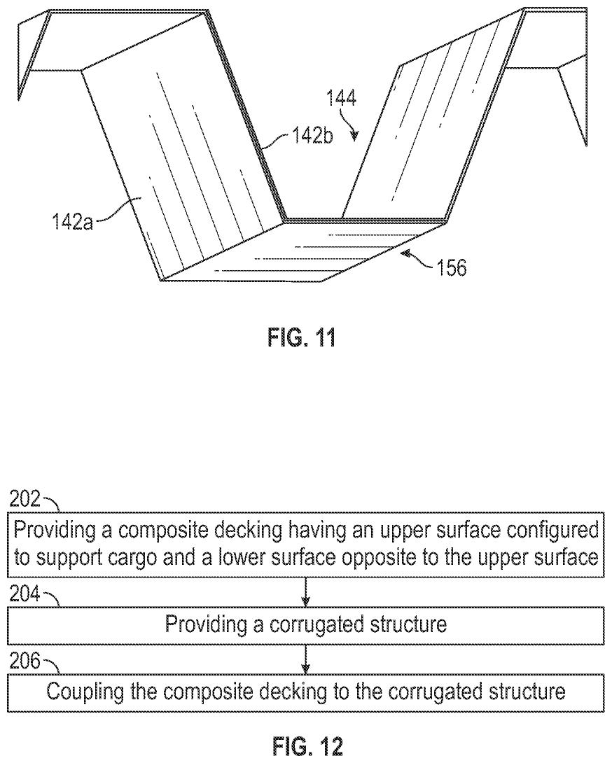

FIG. 11 illustrates a nested corrugated section 156, according to some aspects described herein. The corrugated structure 130 may include one or more nested corrugated sections 156. The nested corrugated section 156 includes at least a portion of a first corrugated section 142a and a second corrugated section 142b from the plurality of corrugated sections 142. By nesting together adjacent corrugated sections, a thickness of the nested areas of the corrugated structure 130 is double a thickness of a non-nested area of the corrugated structure 130, thereby increasing strength of the corrugated structure 130 along at least the nested regions.

The first corrugated section 142a and the second corrugated section 142b may be welded together to form the nested corrugated section 156. For example, the first corrugated section 142a and the second corrugated section 142b may be welded together using a relatively fast and automated welding process (e.g., a welding robot). The first corrugated section 142a and the second corrugated section 142b may be welded along a top of the nested corrugated section 156 and/or along a bottom of the nested corrugated section 156. In some examples, the first corrugated section 142a and the second corrugated section 142b may be welded together, for example, via spot welds and/or stitch welds. Additionally, or alternatively, the first corrugated section 142a and the second corrugated section 142b may be otherwise coupled together, for example via adhesives, chemical bonding, fasteners, etc.

In some examples, the first corrugated section 142a and the second corrugated section 142b may be coupled together continuously along a width of the first corrugated section 142a and the second corrugated section 142b. During assembly of the floor assembly 108, after the first corrugated section 142a and the second corrugated section 142b are coupled together, the filler material 150 may be poured into the channels 144 of the corrugated structure 130. The filler material 150 may be in a liquid form when it is poured. Therefore, the first corrugated section 142b may be coupled together continuously along the width of the first and second corrugated sections 142a, 142b, such that leakage of liquid (e.g., liquid filler material) between the first corrugated section 142a and the second corrugated section 142b is reduced, during assembly of the floor assembly 108. Further, the first side wall 146 and the second side wall 148 may be continuously coupled to the nested corrugated section 156, such that leakage of liquid (e.g., liquid foam) between the nested corrugated section 156 and the first side wall 146 and/or the second side wall 148 is reduced.

FIG. 12 illustrates a method 200 of assembling a floor assembly for a cargo vehicle, according to some aspects described herein. The method 200 begins at a step or operation 202 at which a corrugated structure is provided. The corrugated structure may be similar to the corrugated structure 130 described earlier herein with respect to floor assembly 108. For example, the corrugated structure may include a plurality of corrugated sections that each form respective channels. In some examples, method 200 includes coupling the plurality of corrugated sections together to form one or more nested corrugated sections. For example, the plurality of corrugated sections may be coupled together via welding.

At a step or operation 204, a composite decking is provided. The composite decking may be similar to the composite decking 128 described earlier herein with respect to floor assembly 108. For example, the composite decking may have an upper surface configured to support cargo and a lower surface opposite to the upper surface. Further, the lower surface may be substantially flat.

At a step or operation 206, the composite decking is coupled to the corrugated structure. The composite decking may be coupled to the corrugated structure to improve a load carrying capacity of the composite decking. In some examples, the composite decking may be coupled to the one or more nested corrugated sections. Coupling the composite decking to the one or more nested corrugated sections may further improve the load carrying capacity of the composite decking.

In some examples, method 200 further includes pouring a foam into each of the channels of the plurality of corrugated sections. In some examples, the foam may be a relatively heavy foam with rigid properties, such as a urethane foam. In some examples, the nested corrugated sections may be coupled to the composite decking, via the foam material. In some examples, curing the filling material bonds the lower surface of the composite decking to a top of the corrugated structure. In some methods the corrugated sections may be otherwise coupled to the composite decking, for example via an adhesive. For example, the adhesive may be applied to at least one of the composite decking or the corrugated structure, and curing the adhesive may bond the lower surface of the composite decking to the top of the corrugated structure.

In some examples, the method 200 further includes coupling side walls to the corrugated structure. The side walls may be similar to the first side wall 146 and the second side wall 148 described earlier herein with respect to the floor assembly 108. Further, the side walls may be removably coupled to the corrugated structure, for example, via mechanical fasteners (e.g., bolts). Additionally, or alternatively, the side walls may be otherwise coupled to the corrugated structure (e.g., via adhesive, welding, bonding, etc.). In some examples, the side walls may be coupled to the corrugated structure, prior to providing the composite decking and/or coupling the composite decking to the corrugated structure. In some examples, the side walls may have opening or apertures through which the filler material (e.g., a polymer and/or foam) is inserted into the corrugated structure.

In some examples, a first side wall may be coupled to the corrugated structure, prior to the corrugated structure being coupled to the composite decking. After the composite decking is coupled to the corrugated structure, the corrugated structure may be filled with filler material. Further, after the corrugated structure is filled with filler material, then a second side wall may be coupled to the corrugated structure on the side at which the filler material was inserted into the corrugated structure. Therefore, in some examples, a first side wall may be coupled to the corrugated structure prior to the filler material being poured into the corrugated structure, and a second side wall may be coupled to the corrugated structure after the filler material is poured into the corrugated structure.

The composite structures of the present disclosure (e.g., the composite decking 128) may be formed by a molding process. Additional information regarding the construction of composite structures is disclosed in the following patents and published patent applications, each of which is incorporated by reference in its entirety herein: U.S. Pat. Nos. 5,429,066, 5,664,518, 5,800,749, 5,830,308, 5,897,818, 5,908,591, 6,004,492, 6,013,213, 6,206,669, 6,497,190, 6,543,469, 6,723,273, 6,755,998, 6,869,561, 6,911,252, 8,474,871, 10,239,265, 10,919,579, and 11,338,862.

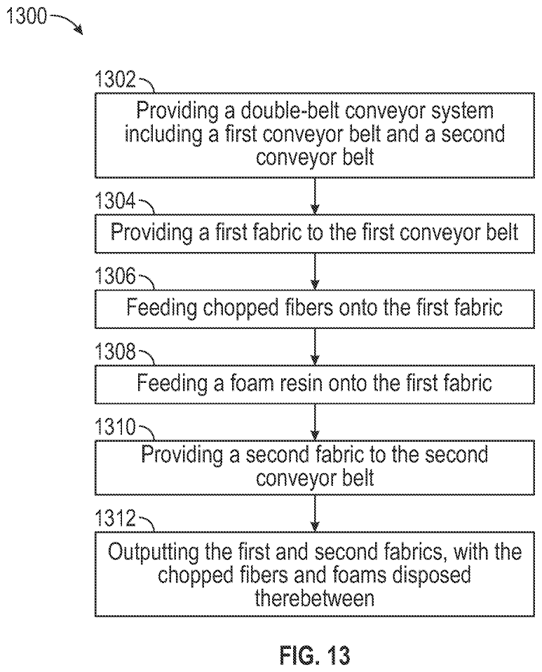

FIG. 13 illustrates a method 1300 of manufacturing a composite floor assembly, according to some aspects described herein. The method 1300 is merely an example and additional and/or alternative methods for manufacturing a composite floor assembly, in accordance with aspects described herein, should be recognized by those of ordinary skill in the art. In some examples, one or more aspects of the method 1300 are performed automatically. In some examples, one or more aspects of the method 1300 are performed manually. In some examples, the entire method 1300 is performed automatically.

In some examples, the method 1300 includes step 1302 of providing a conveyor system. In some examples, the conveyor system is a double-belt conveyor system that includes a first conveyor belt and a second conveyor belt. In some examples, the first conveyor belt is spaced apart from the second conveyor belt. In some examples, the first conveyor belt is vertically spaced apart from the second conveyor belt, such as with respect to the direction of gravity. In some examples, the first conveyor belt and/or the second conveyor belt are 5 feet wide, or 6 feet wide, or 7 feet wide, or 8 feet wide.

In some examples, the method 1300 includes step 1304 of providing a first fabric to the first conveyor belt, such that the first fabric travels with a movement of the first conveyor belt. In some examples, the first fabric has continuous unidirectional fibers. In some examples, the first fabric is substantially made of continuous unidirectional fibers, such that it is defined by continuous unidirectional fibers. In some examples, the first fabric includes fibers of high stiffness and/or strength (e.g., carbon fibers, S-glass fibers, etc.). In some examples, the continuous unidirectional fibers provide stiffness and strength against out-of-plane bending.

In some examples, the method 1300 includes step 1306 of feeding chopped fibers onto the first fabric. For example, the chopped fibers may be fed onto the first fabric via a hopper. In some examples, the chopped fibers are fed onto the first fabric, as the first fabric travels along or with a motion of the first conveyor belt. In some examples, the chopped fibers are randomly sized, randomly spaced apart, and/or randomly oriented fibers. For example, the chopped fibers may include a first fiber and a second fiber. In some examples, the first fiber is different than the second fiber. In some examples, the first fiber and the second fiber have different lengths. In some examples, the random-length and/or random-orientation fibers provide shear and compression strength and/or stiffness.

In some examples, the method includes step 1308 of feeding a foam resin onto the first fabric. In some examples, the foam resin is a polyurethane foam resin. In some examples, the foam has a density of between about 10 and about 20 pounds per cubic foot (pfc).

In some examples, the method includes step 1310 of providing a second fabric to the second conveyor belt, such that the second fabric travels with a movement of the second conveyor belt. In some examples, the second fabric has continuous unidirectional fibers. In some examples, the second fabric is substantially made of continuous unidirectional fibers, such that it is defined by continuous unidirectional fibers. In some examples, the second fabric includes fibers of high stiffness and/or strength (e.g., carbon fibers, S-glass fibers, etc.). In some examples, the continuous unidirectional fibers provide stiffness and strength against out-of-plane bending. It may be appreciated that step 1310 may occur simultaneously with any of steps 1304, 1306, or 1308, or step 1310 may occur before or after any of steps 1304, 1306, or 1308.

In some examples, the method includes step 1312 of outputting the first and second fabrics, with the chopped fibers and foam disposed therebetween, such that the first and second fabrics, the chopped fibers, and the foam together form the composite flooring. In other words, the second fabric may be positioned on top of (i.e., vertically above) the foam resin from step 1308 such that the composite flooring is comprised of the foam resin and the chopped fiber/fiber mat positioned intermediate the first and second fabrics.

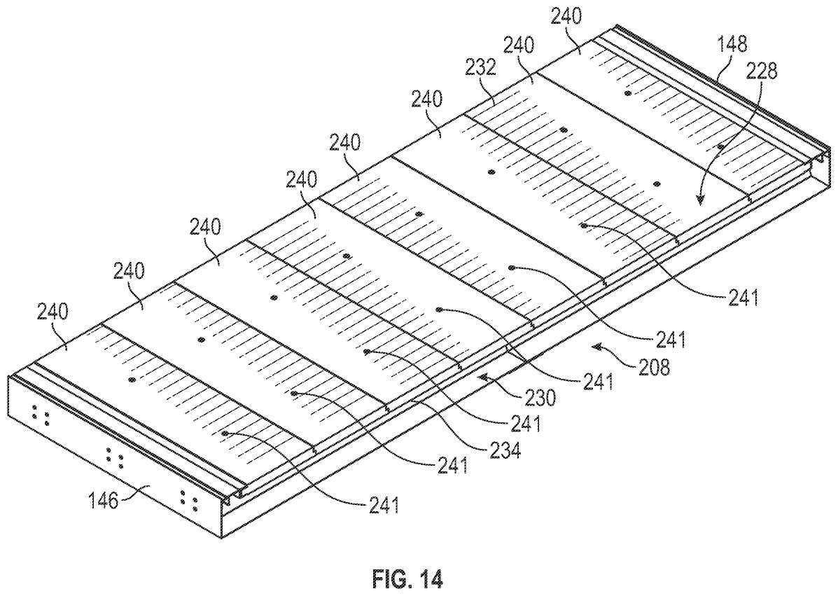

FIG. 14 illustrates a top perspective view of a portion of a floor assembly 208 for a cargo body, according to some aspects described herein. The portion of the floor assembly 208 may be similar to the floor assembly 108 described earlier herein with respect to FIGS. 1-10, except as described herein. The floor assembly 208, in its entirety, may extend, up to, the longitudinal length of the trailer 100, as measured with respect to the longitudinal axis A (see FIG. 1). Additionally, or alternatively, the floor assembly 208 may extend up to a portion of the longitudinal length of the trailer 100, as measured with respect to the longitudinal axis A.

The floor assembly 208 includes decking 228. In some examples, the decking 228 is the same as the composite decking 128 described earlier herein with respect to floor assembly 108. In some examples the decking 228 is different than the composite decking 128 described earlier herein. For example, the decking 228 may be wood decking.

The decking 228 may be formed of one or more panels 240. In some examples, the decking 228 may be formed of a plurality of panels 240 that are coupled together adjacent to each other. Additionally or alternatively, the decking 228 may be a single panel that extends the full width of the trailer 100. In some examples, the panels 240 are wood panels. In some examples, the one or more panels 240 may have a width of about a half-foot, or about one foot, or about two feet. In some examples, the one or more panels 240 may be generally rectangular, such as to improve efficiency of continuously manufacturing the one or more panels 240.

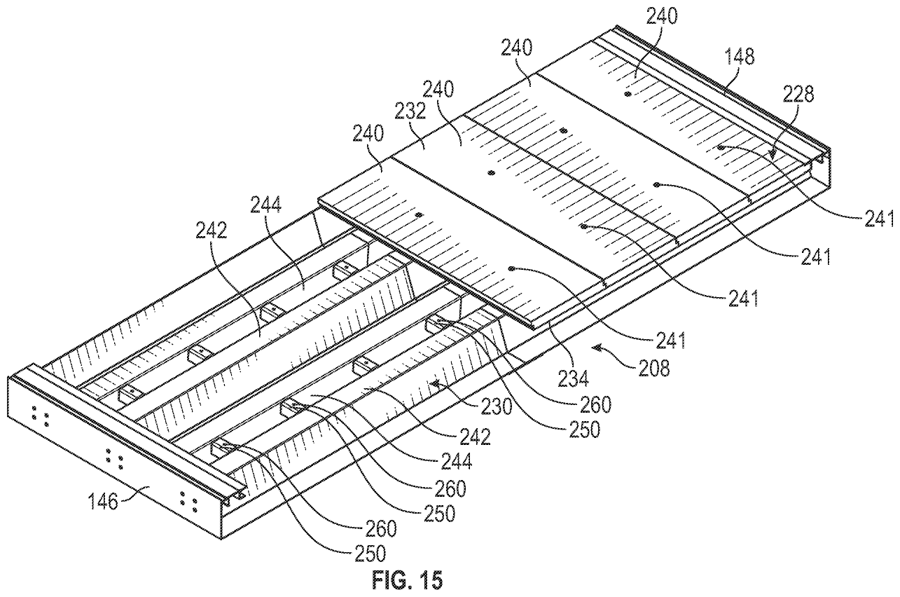

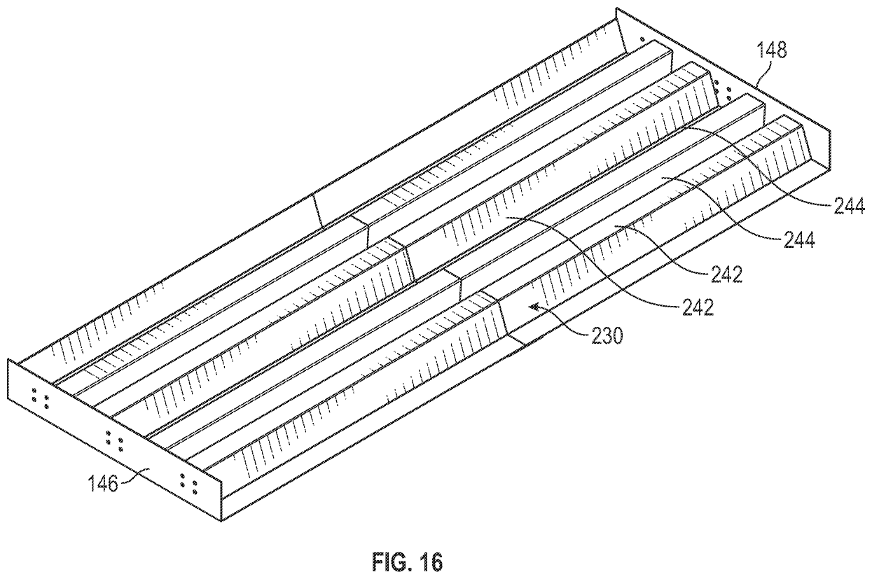

The decking 228 has an upper surface 232 and a lower surface 234 that is opposite to the upper surface 232. The upper surface 232 is configured to support cargo and/or a material handling vehicle that disposes cargo onto the upper surface 232. The floor assembly 208 further includes a corrugated structure 230 (see FIG. 15). The corrugated structure 230 is coupled to the lower surface 234 of the decking 228. The corrugated structure 230 is described in further detail later herein.

The decking 228 is substantially flat. For example, the upper surface 232 and/or the lower surface 234 may be substantially flat. Specifically, in some examples, the upper surface 232 and the lower surface 234 may each define planar surfaces that are parallel with respect to each other. In some examples, the decking 228 may be substantially solid between the upper surface 232 and the lower surface 234 (e.g., void of cutouts, cavities, channels, or other substantial negative space). Further, the upper surface 232 and the lower surface 234 may be substantially smooth. Additionally, or alternatively, the decking 228 (e.g., the upper surface 232 and/or the lower surface 234) may be void of lumps, ribs, corrugations, or other structures that those of ordinary skill in the art may associate with uneven surfaces.

FIG. 15 illustrates the floor assembly 208 of FIG. 14, with a portion of the decking 228 of the floor assembly 208 hidden to show latching blocks, according to some aspects described herein. The panels 240 include one or more holes 241 extending therethrough. The one or more holes 241 are sized and shaped to receive mechanical fasteners therethrough (e.g., screws, such as self-tapping screws, bolts, rivets, etc.). In some examples, the corrugated structure 230 is coupled to the one or more panels 240, via the mechanical fasteners that extend through the one or more holes 241. In some examples, such as when the panels 240 are wooden, it is desirable to use mechanical fasteners (e.g., as opposed to adhesive) because the moisture content of wood may change, and/or the wood may shrink/expand.

In some examples, the floor assembly 208 includes one or more locking pieces 250. In some examples, one or more locking pieces 250 is a plurality of locking pieces 250. The locking pieces 250 may be used to couple the corrugated structure 230 to the decking 228. In some examples, the locking pieces 250 are disposed within the corrugated structure 230. In some examples, the locking pieces 250 are wedged within the corrugated structure 230, such that the locking pieces 250 will not fall out of the corrugated structure 230. For example, the locking pieces 250 may be wedged within one or more channels 244 of the corrugated structure, described in further detail below.

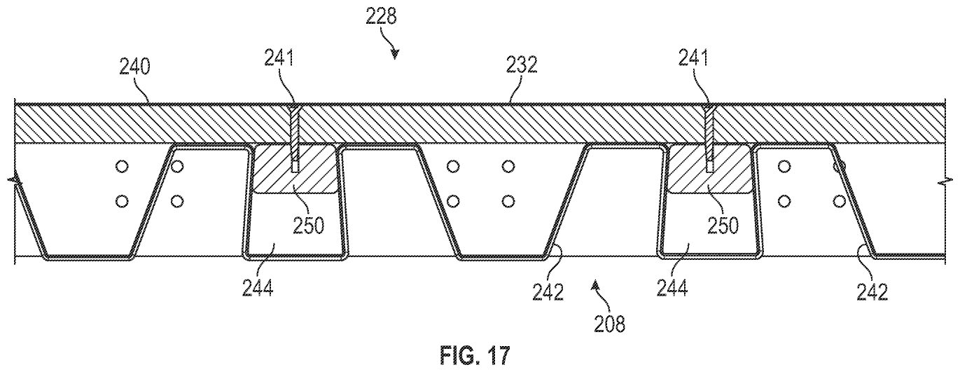

FIG. 16 illustrates a top perspective view of the corrugated structure 230 of the portion of the floor assembly 208 of FIG. 14. Further, FIG. 17 illustrates an enlarged cross-sectional view of the portion of the floor assembly 208 of FIG. 14, according to some aspects described herein. In some examples, the corrugated structure 230 may be similar to the corrugated structure 130 described earlier herein with respect to floor assembly 108, such as except for the difference described below.

The corrugated structure 230 may include one or more corrugated sections 242 that each include or form the respective channels 244. In some examples, one or more of the channels 244 narrow as they approach the decking 228. In some examples, one or more of the channels 224 may not narrow as they approach the decking 228 (e.g., walls of the corrugated structure 230, which form the channels 224, may extend orthogonal with respect to the decking 226). In instances where the channels 244 narrow near the top (e.g., adjacent to the decking 228), the narrowing helps to prevent the locking pieces 250 from coming out of the corrugated structure 230. In some examples, the narrowing of the channels 224 may be defined by a slant angle. In some examples, the slant angle may be about 5 degrees from a vertical (e.g., defined by a line and/or plane extending orthogonally through the upper surface 232 and/or the lower surface 234 of the decking 228). In some examples, the slant angle may be about 10 degrees with respect to the vertical.

In some examples, the corrugated structure 230 includes (e.g., is formed of) a metal, such as, steel (e.g., high strength steel, an alloy containing steel and copper, such as weathering steel, etc.), aluminum, etc. In some examples, the metal may be galvanized or otherwise protected from corrosion. Additionally, or alternatively, in some examples the corrugated structure 230 includes (e.g., is formed of) a composite laminate. The composite laminate may include at least a resin matrix and fiber reinforcements. In some examples, the corrugated structure 230 includes at least one of the steel or the composite laminate.

Generally, the corrugated structure 230 helps to increase the carrying load of the decking 228, such as for a material handling vehicle to drive thereon. The corrugated structure 230 may be roll formed, pressed, stamped, or otherwise manufactured using methods recognized by those of ordinary skill in the art. The corrugated structure 230 may have a width of about 22.5 inches and/or a height of about 4 inches. However, in some examples, the corrugated structure may be manufactured with any width or height desired by a manufacturer.

In some examples, the one or more corrugated sections 242 is a plurality of corrugated sections 242. The plurality of corrugated sections 242 may be coupled together, such as, for example, via one or more of welding, adhesive bonding, chemical bonding, or crimping. Additional and/or alternative mechanisms for coupling together the plurality of corrugated sections 242 may be recognized by those of ordinary skill in the art.

In some examples, the locking pieces 250 are preassembled with the panels 240 using mechanical fasteners. In some examples, the positioning of the locking pieces 250 corresponds to a location of the channels 244 of the corrugated structure 230 with narrowing gaps at the top. In some examples, when the locking pieces 250 are rotated into position inside the channels 244, the locking pieces 250 are locked in place. In some examples, a mechanical fastener extending through the panels 240 is driven further to pull the locking piece 250 up against the bottom side 234 of the decking 228 and deadlocks at the top of the corrugated structure 230, such that the locking pieces 250 are fixed inside the corrugated structure, in some examples.

In some examples, mechanical fasteners installed in the decking 228 (e.g., the panels 240 of the decking) and driven into the locking pieces 250 prevent the panels 240 from moving (e.g., when a forktruck is driving along them). In some examples, an adhesive may be used between the bottom side 234 of the decking 228 and atop of the corrugated structure 230 for a stronger connection. Some benefits of the floor assembly 208 include allowing a mechanical connection between the panels 240 and the corrugated structure, while using fewer mechanical connections than conventional techniques.

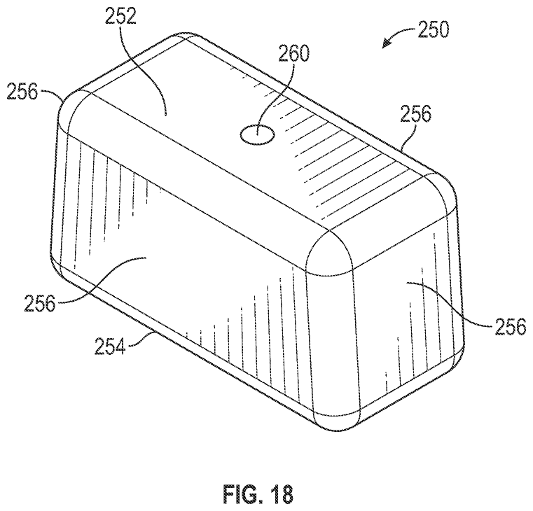

FIG. 18 illustrates the locking piece 250 of FIG. 15 according to some aspects described herein. In some examples, the locking piece 250 includes a top side 252, a bottom side, 254, and one or more walls 256. The top side 252 includes a hole 260. In some examples, the hole 260 is tapped. In some examples, the hole 260 is counter bore, counter sunk, plain, thru, or another type of hole that may be recognized by those of ordinary skill in the art. In some examples, the hole 260 is sized and shaped to receive a mechanical fastener, such as a mechanical fastener extending through the decking 228, via the holes 241 of the decking 228.

In some examples, the locking piece 250 is a block. In other examples, the locking piece 250 may be a bar, or a sphere, or a cone, or another type of geometric structure recognized by those of ordinary skill in the art. In some examples, the locking piece 250 may be substantial solid. In other examples, the locking piece 250 may be substantially hollow.

In some examples, a slant angle of two or more of the walls 256 corresponds to a slant angle of the channels 244 in which the locking pieces 250 are to be disposed. In some examples, the slant angle of the two or more walls 256 of the locking piece may be an offset of about 5 degrees from a vertical (e.g., defined by a line extending orthogonally through the top side 252 and/or the bottom side 254 of the locking piece 250). In some examples, the slant angle may be about 10 degrees with respect to the vertical.

In some examples, an area of the top side 252 of the locking piece 250 is less than an area of the bottom side 254 of the locking piece 250, such as due to the slant angle. In some examples, an area of the top side 252 is between 50% and 100% of the area of the bottom side 254. In some examples, the top side 252 has a perimeter that is between 50% and 100% of the perimeter of the bottom side 254 (i.e., less than the perimeter of the bottom side 254), such as due to the slant angle. In some examples, the top side 252 has a perimeter that is between 75% and 100% of the perimeter of the bottom side 254.

In some examples, the locking piece 250 is made at least in part of a polymer. In some examples, the locking piece 250 is made at least in part of an injection molded nylon. In some examples, the locking piece is made at least in part of a wood, a metal, a fabric, and/or any other material that may be recognized by those of ordinary skill in the art.

While this invention has been described as having exemplary designs, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A floor assembly for a cargo vehicle, comprising:
a composite decking having an upper surface configured to support cargo and a lower surface opposite to the upper surface, the lower surface being substantially flat; and
a corrugated structure coupled to the lower surface of the composite decking, the corrugated structure comprising one or more corrugated sections that each form respective channels.

2. The floor assembly of claim 1, wherein the composite decking and the corrugated structure are adjoined continuously with respect to each other.

3. The floor assembly of claim 1, wherein the corrugated structure comprises at least one of a metal or a composite laminate comprising at least a resin matrix and fiber reinforcements.

4. The floor assembly of claim 1, wherein the channels are filled with filler material, and wherein the filler material comprises one or more of a foam or a low-density polymer.

5. The floor assembly of claim 4, wherein the filler material couples together the corrugated structure and the composite decking.

6. The floor assembly of claim 1, further comprising:
one or more rails for a slider suspension, the one or more rails being coupled to the corrugated structure.

7. The floor assembly of claim 6, further comprising a plurality of gussets, wherein each of the one or more rails are coupled to the corrugated structure via the plurality of gussets.

8. The floor assembly of claim 7, wherein the corrugated structure comprises one or more nested corrugated sections, and wherein each of the one or more nested corrugated sections comprises at least a portion of a first corrugated section and a second corrugated section from the plurality of corrugated sections.

9. The floor assembly of claim 8, wherein the first corrugated section and the second corrugation section are coupled together via one or more of welding, adhesive bonding, or crimping.

10. A floor assembly for a cargo vehicle, comprising:
a composite decking having an upper surface configured to support cargo and a lower surface opposite to the upper surface; and
a corrugated structure that is coupled to the lower surface of the composite decking, the corrugated structure comprising:
a plurality of corrugated sections, the plurality of corrugated section comprising a first corrugated section and a second corrugated section, wherein at least a portion of the first corrugated section is nested with at least a portion of the second corrugated section.

11. The floor assembly of claim 10, wherein the first corrugated section and the second corrugation section are coupled together via one or more of welding, adhesive bonding, or crimping.

12. The floor assembly of claim 10, wherein the one or more corrugated sections each form respective channels, and wherein the channels are each filled with filler material, the filler material being one or more of a foam or a low-density polymer.

13. The floor assembly of claim 12, wherein the filler material couples the corrugated structure and the composite decking.

14. The floor assembly of claim 10, wherein the corrugated structure comprises at least one of a metal or a composite laminate comprising a plurality of resin matrixes and fiber reinforcements.

15. The floor assembly of claim 10, further comprising:
one or more rails for a slider suspension, the one or more rails being coupled to the corrugated structure.

16. The floor assembly of claim 10, further comprising a plurality of gussets, wherein each of the one or more rails are coupled to the corrugated structure via the plurality of gussets.

17. A method of assembling a floor assembly for a cargo vehicle, the method comprising:
providing a corrugated structure;
providing a composite decking having an upper surface configured to support cargo and a lower surface opposite to the upper surface, the lower surface being substantially flat; and
coupling the composite decking to the corrugated structure.

18. The method of claim 17, wherein the corrugated structure comprises a plurality of corrugated sections, wherein each of the plurality of corrugated sections form respective channels, and wherein the method further comprises coupling the plurality of corrugated sections together to form one or more nested corrugated sections, the composite decking being coupled to the one or more nested corrugated section.

19. The method of claim 18, further comprising pouring a foam material into each of the channels of the plurality of corrugated sections, wherein the coupling the composite decking to the corrugated structure includes coupling the nested corrugated sections to the composite decking via the foam material.

20. The method of claim 17, further comprising:
coupling side walls to the corrugated structure.

21. A method of manufacturing a composite flooring, the method comprising:
providing a double-belt conveyor system comprising a first conveyor belt and a second conveyor belt, the first conveyor belt being spaced apart from the second conveyor belt;
providing a first fabric to the first conveyor belt, such that the first fabric travels with a movement of the first conveyor belt;
feeding chopped fibers onto the first fabric;
feeding a foam resin onto the first fabric;
providing a second fabric to the second conveyor belt, such that the second fabric travels with a movement of the second conveyor belt;
outputting the first and second fabrics, with the chopped fibers and foam disposed therebetween, such that the first and second fabrics, the chopped fibers, and the foam together form the composite flooring.

22. The method of claim 21, wherein the first and second fabrics are defined by continuous unidirectional fibers.

23. The method of claim 21, wherein the foam resin is a polyurethane foam.

24. The method of claim 21, wherein the chopped fibers comprise a first fiber and a second fiber, the first fiber being different from the second fiber, and wherein the first and second fibers are different lengths.

25. The method of claim 21, wherein the first conveyor belt is vertically spaced apart from the second conveyor belt, with respect to the direction of gravity.
